(19) United States
(12) Patent Application Publication
(10) Pub. No.: US 2026/0307969 A1
(43) Pub. Date: Oct. 8, 2026

(54) Industrial Truck

(71) Applicant: Linde Material Handling GmbH, Aschaffenburg (DE)

(72) Inventors: Jochen Stromberg, Mömbris (DE); Michael Wuttke, Alzenau-Hörstein (DE)

(21) Appl. No.: 19/637,147

(22) Filed: Apr. 2, 2026

(30) Foreign Application Priority Data
Apr. 7, 2025 (DE) 102025113502.9
Apr. 9, 2025 (DE) 102025113980.6

(51) Int. Cl. B66F 17/00; B60K 28/04; B66F 9/075

(52) U.S. Cl. CPC B66F 17/003; B60K 28/04; B66F 9/0759

(57) ABSTRACT

An industrial truck with an operator compartment that has a driver’s seat and a floor, wherein the industrial truck, in a footwell located above the floor of the operator compartment, has a deadman switch device that is configured to detect the presence of at least part of a leg of an operator seated on the driver’s seat. The deadman switch device has a contactless sensor device which is configured to detect the presence of at least part of a leg in the footwell, wherein the contactless sensor device is configured, when it detects part of the leg in the footwell, to emit a travel enabling signal to a control unit of the industrial truck that controls the propulsion unit of the industrial truck.

### CROSS-REFERENCE TO RELATED APPLICATIONS

This application claims priority to German Patent Application No. 102025113502.9 filed Apr. 7, 2025, and German Patent Application No. 102025113980.6 filed Apr. 9, 2025, the disclosures of which are hereby incorporated by reference in their entireties.

### BACKGROUND OF THE INVENTION

### FIELD OF THE INVENTION

The disclosure relates to an industrial truck with an operator compartment that has a driver’s seat and a floor, wherein the industrial truck has a deadman switch device that is configured to detect the presence of at least one leg of an operator seated on the driver’s seat in a footwell located above the floor of the operator compartment.

### DESCRIPTION OF RELATED ART

Industrial trucks with an operator compartment that includes a driver’s seat are operated by an operator sitting on the driver’s seat. For the safe operation of the industrial truck it is necessary to ensure that for the industrial truck to travel, both of the operator’s legs are inside the operator compartment or its footwell and therefore inside the vehicle contour of the industrial truck.

For this purpose, it is known that a deadman switch device can be provided on the floor of the operator compartment on which the operator seated on the driver’s seat places both legs during the operation of the industrial truck, which device includes one or more deadman switches, each of which has a deadman switch pedal that must be actuated and depressed by the operator seated on the driver’s seat with one or both legs for the travel of the industrial truck.

A generic industrial truck with a driver’s seat and a deadman switch device configured in the form of two deadman pedals on the floor of the operator compartment is known from EP 2 116 434 A1.

One disadvantage of known industrial trucks in which, as the deadman switch device, at least one deadman switch pedal is located on the floor of the operator compartment and is actuated and must be depressed with one leg by the operator seated on the driver’s seat for the travel of the industrial truck, is that it results in unfavorable ergonomic conditions for the operator, because when the industrial truck travels over long distances, as a result of the required body position or leg position and the need to constantly exert the actuation force on the deadman pedal to keep it activated during the travel of the industrial truck, the operator actuating the deadman switch can experience fatigue and/or cramps in his or her leg or foot.

Although an ergonomic layout of the deadman switch pedal on the floor of the operator compartment is determined in the design phase of the industrial truck, it is not always suitable for all operators operating the industrial truck, because human beings come in very different sizes and proportions and also favor different postures while operating the industrial truck.

### SUMMARY OF THE INVENTION

The object of this disclosure is to make available an industrial truck of the type cited above that offers improved ergonomic conditions for the operator.

This object is accomplished according to the disclosure in that the deadman switch device has a contactless sensor device that is configured to detect the presence of at least a portion of a leg in the footwell, wherein the contactless sensor device is configured so that when it detects a portion of the leg in the footwell it emits a travel enabling signal to a control unit of the industrial truck that controls the propulsion unit of the industrial truck.

According to the disclosure, instead of a deadman switch pedal on the floor, the actuation of which requires an actuation force applied by one leg or foot of the operator seated on the driver’s seat, the deadman switch provided is a contactless sensor device that detects the presence in the footwell of the operator compartment of at least part of a leg of the operator seated on the driver’s seat. For this purpose the contactless sensor device is positioned in the industrial truck so that the sensor device can be activated only if the leg in question, for example the calf (lower leg) or the respective foot, is in the footwell of the operator compartment and thus inside the vehicle contour.

The contactless sensor device is configured to emit a travel enabling signal to a control unit that controls the drive unit of the industrial truck if it detects a part of a leg, for example a calf (lower leg) or foot, in the footwell. It is thereby ensured that for the travel of the industrial truck, the corresponding leg of the operator seated on the driver’s seat is inside the footwell of the operator compartment and thus inside the vehicle contour.

The contactless sensor device does not require any actuation force that must be applied by the leg or foot of an operator seated on the driver’s seat and makes it possible for the operator seated on the driver’s seat to hold a leg in a relaxed position and in different positions in front of the contactless sensor device to trigger the travel enabling signal, which results in improved ergonomic conditions and increased comfort for the operator operating the industrial truck.

According to one advantageous embodiment of the disclosure, the contactless sensor device is configured so that when it does not detect a part of the leg in the footwell, it emits a travel disabling signal to the control unit of the industrial truck that controls the propulsion unit of the industrial truck. The operational safety of the industrial truck is thereby increased because the industrial truck can only travel if the contactless sensor device emits a travel enabling signal when it detects a leg in the footwell of the operator compartment.

According to one advantageous embodiment of the disclosure, located on the floor is an accelerator pedal device which includes at least one accelerator pedal, wherein the contactless sensor device is configured to detect a leg on the accelerator pedal. Consequently, the contactless sensor device is able in a simple manner to detect that a leg of the operator seated on the driver’s seat is located in the footwell of the operator compartment.

According to one advantageous embodiment of the disclosure, the accelerator pedal device is a single-pedal device that has a single accelerator pedal, wherein the contactless sensor device is configured to detect a leg on the accelerator pedal. A single-pedal device has a single accelerator pedal with which the speed of travel of the industrial truck can be controlled and is generally actuated with the right foot of the operator seated on the driver’s seat. On an industrial truck with a single-pedal device, the direction of travel can be selected with a directional control switch. The contactless sensor device is able in a simple manner to detect that a right leg of the operator seated on the driver’s seat is located in the footwell of the operator compartment.

Alternatively or additionally, on an industrial truck with a single-pedal device that has a single accelerator pedal, the contactless sensor device can be configured to detect the presence of at least part of a leg in a pedal free space located laterally next to the accelerator pedal. On an industrial truck with a single-pedal device, the left leg of the operator seated on the driver’s seat is located in the pedal free space which is located laterally next to the accelerator and forms part of the footwell of the operator compartment. The contactless sensor device is able in a simple manner to detect that a left leg of the operator seated on the driver’s seat is located in the footwell of the operator compartment.

According to one advantageous embodiment of the disclosure, an accelerator pedal device is a two-pedal device that has a forward accelerator pedal and a reverse accelerator pedal, wherein the contactless sensor device is configured to detect a leg on the forward accelerator pedal and/or a leg on the reverse accelerator pedal. A two-pedal device has a forward accelerator pedal with which forward travel and the speed of travel in the forward direction can be controlled, and a reverse accelerator pedal with which reverse travel and the speed of travel in the reverse direction can be controlled. The forward accelerator pedal is actuated with a foot, for example the left or right foot, of the operator seated on the driver’s seat, and the reverse accelerator pedal is actuated with the other foot, for example the right or left foot, of the operator seated on the driver’s seat. The contactless sensor device is therefore able in a simple manner to detect that the right leg or the left leg or both legs of the operator seated on the driver’s seat are located in the footwell of the operator compartment.

According to one advantageous embodiment of the disclosure, located on the floor is a brake pedal device which includes at least one brake pedal, wherein the contactless sensor device is configured to detect a leg on the brake pedal. A braking device can be actuated with the brake pedal. The brake pedal is preferably located so that it can be actuated with both legs of the operator seated on the driver’s seat. If the industrial truck is provided with a brake pedal on the floor, the contactless sensor device can detect in a simple manner that the right or left leg of the operator seated on the driver’s seat is located in the footwell of the operator compartment.

According to one advantageous embodiment of the disclosure, the contactless sensor device has a detection range directed into in the footwell. Consequently the contactless sensor device can reliably and in a simple manner detect a leg in the footwell of the operator compartment.

According to one advantageous embodiment of the disclosure, the contactless sensor device is located in the footwell of the operator compartment opposite the driver’s seat and has a detection range directed toward the floor. With the contactless sensor device in such a location, the contactless sensor device can reliably detect a calf (lower leg) or foot of a corresponding leg of the operator seated on the driver’s seat.

According to one advantageous embodiment of the disclosure, the contactless sensor device is configured as a retroreflective or reflex switch, in particular an LED sensor, or an ultrasound sensor or an infrared sensor or a laser sensor or an inductive sensor or a capacitive sensor or a radar sensor or a camera.

For example, with a retroreflective switch in the form of an LED sensor which, by emitting light and receiving the reflection of the light off the shoe or leg or pants leg of the operator seated on the driver’s seat, measures the distance to a leg located in the footwell of the operator seated on the driver’s seat, and by means of a distance measurement and specified parameter values (distance range of the leg from the LED sensor), it is possible in a simple and operationally reliable manner to detect a leg located in the footwell of the operator compartment of the operator seated on the driver’s seat and to generate and output the travel enabling signal (“Leg detected in footwell”) or the travel disabling signal (“Leg not detected in footwell”).

According to one advantageous embodiment of the disclosure, the industrial truck is in the form of a counterbalanced forklift truck or a reach truck or a lift truck. An ergonomically actuated deadman switch device can be achieved with the contactless sensor device according to the disclosure on an industrial truck in the form of a counterbalanced forklift truck or a reach truck or a lift truck that is operated by an operator seated on the driver’s seat.

The disclosure achieves a series of advantages.

The disclosure with the deadman switch device in the form of a contactless sensor device makes possible a contactless monitoring of the presence of a leg in the footwell of the operator compartment of the industrial truck which is operated by the operator seated on the driver’s seat.

The disclosure offers improved ergonomic conditions and increased comfort for the operator seated on the driver’s seat and operating the industrial truck.

On the industrial truck according to the disclosure, all the operator seated on the driver’s seat has to do is to keep the leg in question, for example the calf (lower leg) or the foot, within the coverage range of the contactless sensor device to activate the deadman switch device and generate the travel enabling signal; however, the operator can relax the leg in question or hold it in different leg positions and is spared the need to have to apply an actuation force in the footwell of the operator compartment. When the deadman switch device is activated, the leg in question can also be moved in the range of the contactless sensor device, as a result of which fatigue and/or cramps in the leg actuating the deadman switch device of the operator seated on the driver’s seat can be prevented during travel of the industrial truck over longer distances.

With the contactless sensor device according to the disclosure, an ergonomic actuation of the deadman switch device becomes possible for the widest possible range of different bodily proportions of the operator and the widest possible range of postures or leg positions of the operator seated on the driver’s seat.

### BRIEF DESCRIPTION OF THE DRAWINGS

The terms Fig., Figs., Figure, and Figures are used interchangeably in the specification to refer to the corresponding figures in the drawings.

Additional advantages and details of the disclosure are described in greater detail below with reference to the exemplary embodiments illustrated in the accompanying schematic figures, in which

FIG. 1 shows an industrial truck according to the disclosure in a view of the operator compartment.

FIG. 2 is a detail of FIG. 1 in an enlarged illustration, and

FIG. 3 is a detail of FIG. 2 that explains the functioning of the deadman switch device.

### DESCRIPTION OF THE INVENTION

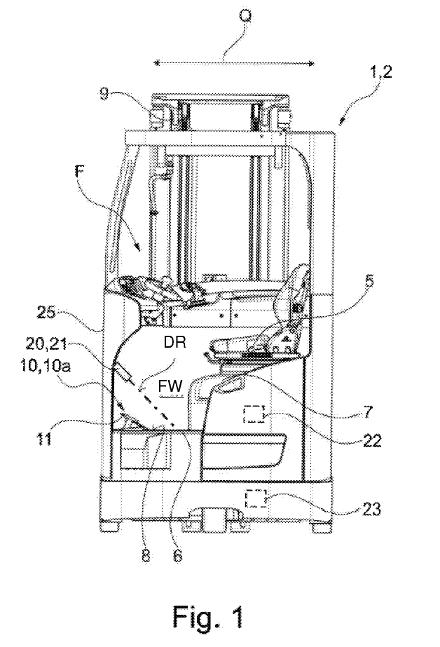

FIG. 1 shows an industrial truck 1 according to the disclosure in a view of the operator compartment F.

In the illustrated exemplary embodiment, the industrial truck is in the form of a reach truck 2.

The operator compartment F has a driver’s seat 5 and a floor 6. The driver’s seat 5 is located above a hood-like cover 7 of a motor compartment of the industrial truck 1.

In the illustrated exemplary embodiment of a reach truck 2, the longitudinal direction of the driver’s seat 5 is in the transverse direction Q of the reach truck vehicle 2.

The floor 6 - viewed in the transverse direction Q of the vehicle - is located in front of the driver’s seat 5.

An operator seated on the driver’s seat 5 can place his or her feet RF, LF and/or legs RL/LL on the floor 6. The floor 6 has a footrest 8 on the upper side for this purpose. The operator compartment F is configured as a footwell FW vertically above the floor 6 and its footrest 8. The footwell FW and the footrest 8 are preferably configured so that an operator seated on the driver’s seat 5 can position his or her legs RL, LL in the footwell FW and can place his or her feet RF, LF on the footrest 8 of the floor 6.

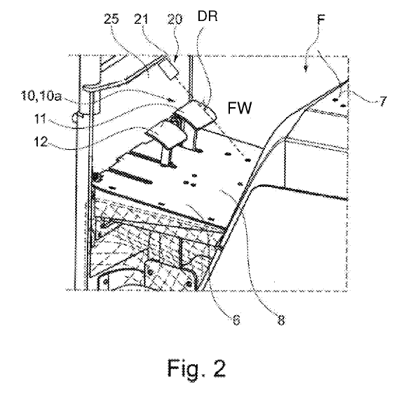

In the illustrated exemplary embodiment, an accelerator pedal device 10 is located on the floor 6 - as illustrated in greater detail in connection with FIG. 2.

In the illustrated exemplary embodiment the accelerator pedal device 10 is a single-pedal device 10a which has a single accelerator pedal 11, which in the illustrated embodiment is actuated with the right leg RL of the operator seated on the driver’s seat 5 and can be pushed downward relative to the floor 6. The speed of travel of the industrial truck 1 in the forward direction and in the reverse direction can be controlled with the accelerator pedal 11.

On an industrial truck 1 in the form of a reach truck 2, the forward direction of travel represents travel of the reach truck 2 with the operator compartment F in front, i.e. in FIG. 1 projecting out from the plane of the drawing, and travel in the reverse direction represents travel of the reach truck 2 with a lifting mast 9 in front, i.e. in FIG. 1 projecting into the plane of the drawing.

Located laterally next to the accelerator pedal 11 on the floor 6 is a brake pedal 12 with which a braking device of the industrial truck 1 can be controlled. The brake pedal 12 can be actuated by an operator seated on the driver’s seat 5 with both legs or either leg, i.e. optionally with the right leg RL or the left leg LL, and pushed downward relative to the floor 6.

The industrial truck 1 has a deadman switch device 20 which is configured to detect the presence of at least one leg BR or BL of an operator seated on the driver’s seat 5 in the footwell FM of the operator compartment F located above the floor 6,.

The deadman switch device 20 has a contactless sensor device 21 which is configured to detect the presence of at least part of a leg RL or LL in the footwell FW.

The contactless sensor device 21 is in communication with a control unit 22 of the industrial truck, which is also in communication with the accelerator pedal device 10 and actuates a propulsion unit 23 of the industrial truck 1 as a function of the actuation of the accelerator pedal device 10.

When it detects part of the leg RL or LL in the footwell FW, the contactless sensor device 21 is configured to emit a travel enabling signal to the control unit 22 of the industrial truck 1 that controls the propulsion unit 23 of the industrial truck 1. When the travel enabling signal is emitted, the propulsion unit 23 is actuated by the control unit 22 as a function of the actuation of the accelerator pedal device 10 so that the industrial truck 1 travels in the direction indicated by the driver.

When it does not detect part of the leg RL or LL in the footwell FW, the contactless sensor device 21 is configured to emit a travel disabling signal to the control unit 22 of the industrial truck 1 that controls the propulsion unit 23 of the industrial truck 1. When the travel disabling signal is present, the propulsion unit 23 is not actuated by the control unit 22 so that an actuation of the accelerator pedal device 10 does not result in travel of the industrial truck 1.

In the illustrated exemplary embodiment, the contactless sensor device 21 is located in the area of a vertical outer wall 25 of the industrial truck 1 that delimits the operator compartment F and the footwell FM.

In the illustrated exemplary embodiment, the contactless sensor device 21 is located on the outer wall 25 of the industrial truck 1 at some vertical distance above the floor 6 and has a detection range DR that extends into the footwell FW.

In the illustrated exemplary embodiment, the contactless sensor device 21 located on the outer wall 25 of the industrial truck 1 is located in the footwell FW opposite the driver’s seat 5, at some vertical distance above the floor 6, and has a detection range DR that extends downward and at an angle to the floor 6.

In the illustrated exemplary embodiment, the contactless sensor device 21 is located and configured to detect a part of the leg on the accelerator pedal 11, in the illustrated exemplary embodiment a part of the right leg RL of the operator seated on the driver’s seat 5.

Alternatively or additionally, the contactless sensor device 21 can be located and configured to detect the presence of at least part of a leg in a pedal free space located laterally next to the accelerator pedal 11, in the illustrated exemplary embodiment to detect part of the left leg LL of the operator seated on the driver’s seat 5 which is positioned in the pedal free space next to the accelerator pedal 11 and the brake pedal 12 on the floor 6. Alternatively, a contactless sensor device or an additional contactless sensor device can be provided for the detection of part of the left leg LL of the operator seated on the driver’s seat 5 which is positioned in the pedal free space next to the accelerator pedal 11 and the brake pedal 12.

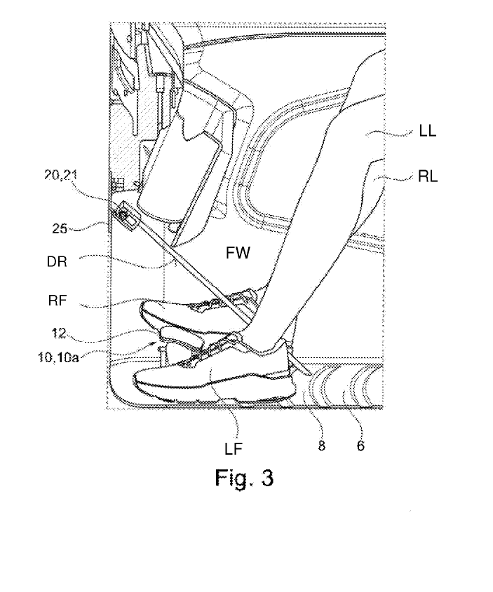

FIG. 3 shows the footwell FW with the right leg RL and the left leg LL of the operator seated on the driver’s seat 5, wherein the right foot RF of the right leg RL is on the accelerator pedal 11 and the left foot LF and the left leg LL are positioned in the pedal free space located laterally next to the accelerator pedal 11 and the brake pedal 12 and on the floor 6.

The detection range DR of the contactless sensor device 21 is thereby directed toward the area of the ankle joint of the right leg RL or toward the area of the ankle joint of the left leg LL.

In the illustrated exemplary embodiment, the contactless sensor device 21 is a retroreflective or reflex switch, for example an LED sensor.

The LED sensor emits light into the footwell FW and receives the reflected light that is reflected when a leg RL, LL is located in the footwell FW off the leg RL, LL or foot RF, LF or shoe or pants leg, and can measure the distance of the reflected light beam. A leg RL, LL is detected by the LED sensor and the travel enabling signal is emitted if the distance measured is within predetermined parameters.

On the other hand, if the measured distance traveled by the reflected light beam is not within the predetermined parameters because, for example, the light beam is reflected off the floor 6, there is no leg RL, LL in the footwell FW and the LED sensor emits the travel disabling signal.

The disclosure is not limited to the illustrated exemplary embodiment.

Instead of an LED sensor as the contactless sensor device 21, the contactless sensor device 21 can be an ultrasound sensor or an infrared sensor or a laser sensor or an inductive sensor or a capacitive sensor or a radar sensor or a camera.

Alternatively, the accelerator pedal device 10 can be a two-pedal device that has a forward accelerator pedal that can be actuated by the operator seated on the driver’s seat 5 with the left leg LL and a reverse accelerator pedal that can be actuated by the operator seated on the driver’s seat 5 with the right leg RL. Between the forward acceleration pedal and the reverse acceleration pedal is the brake pedal 12, which can be actuated by the operator seated on the driver’s seat 5 with both legs or either leg LR, LL, i.e. optionally with the right leg RL or the left leg LL.

When the accelerator pedal device 10 is a two-pedal device, the contactless sensor device 21 is configured to detect a left leg LL on the forward acceleration pedal or a right leg RL on the reverse acceleration pedal.

It is also conceivable that when the accelerator pedal device 10 is a two-pedal device, a first contactless sensor device 21 can be provided that detects a right leg RL on the reverse acceleration pedal and a second contactless sensor device 21 that detects a left leg LL on the forward acceleration pedal.

It is also possible that the control unit 22 is in communication with a sensor device that detects the presence of the operator on the driver’s seat 5, for example a seat switch in the seat surface of the driver’s seat 5, and/or a safety belt switch of a safety belt on the driver’s seat. In that case, the control device 21 is preferably configured so that travel is enabled only if an operator seated on the driver’s seat 5 is detected by the sensor device and the contactless sensor device 21 detects a leg RL or LL in the footwell FW and emits the travel enabling signal.

1. An industrial truck with an operator compartment that has a driver’s seat and a floor, wherein the industrial truck has a deadman switch device which is configured to detect a presence of at least one leg of an operator seated on the driver’s seat in a footwell of the operator compartment configured above the floor, wherein the deadman switch device has a contactless sensor device that is configured to detect the presence of at least part of a leg in the footwell, wherein the contactless sensor device is configured to emit a travel enabling signal to a control unit that controls a propulsion unit of the industrial truck when the contactless sensor device detects part of the leg in the footwell.

2. The industrial truck according to claim 1, wherein the contactless sensor device is configured to emit a travel disabling signal to the control unit of the industrial truck that controls the propulsion unit of the industrial truck when the contactless sensor device does not detect part of the leg in the footwell.

3. The industrial truck according to claim 1, wherein located on the floor is an accelerator pedal device that comprises at least one accelerator pedal, wherein the contactless sensor device is configured to detect the leg on the accelerator pedal.

4. The industrial truck according to claim 3, wherein the accelerator pedal device is a one-pedal device that has a single accelerator pedal wherein the contactless sensor device is configured to detect a leg on the accelerator pedal.

5. The industrial truck according to claim 3, wherein the accelerator pedal device is a one-pedal device that has a single accelerator pedal, wherein the contactless sensor device is configured to detect the presence of at least part of the leg (LL; RL) in a pedal free space located laterally next to the accelerator pedal.

6. The industrial truck according to claim 3, wherein the accelerator pedal device is a two-pedal device that has a forward accelerator pedal and a reverse accelerator pedal, wherein the contactless sensor device is configured to detect the leg on the forward accelerator pedal and/or the leg on the reverse accelerator pedal.

7. The industrial truck according to claim 1, wherein on the floor there is a brake pedal device that comprises at least one brake pedal, wherein the contactless sensor device is configured to detect the leg on the brake pedal.

8. The industrial truck according to claim 1, wherein the contactless sensor device has a detection range directed into the footwell.

9. The industrial truck according to claim 1, wherein the contactless sensor device is located in the footwell opposite the driver’s seat, and has a detection range directed toward the floor.

10. The industrial truck according to claim 1, wherein the contactless sensor device is a retroreflective or reflex switch, or an ultrasound sensor or an infrared sensor or a laser sensor or an inductive sensor of a capacitive sensor or a radar sensor of a camera.

11. The industrial truck according to claim 1, wherein the industrial truck is a counterweighted forklift truck or a reach truck or a lift truck .
